(19) United States
(12) Patent Application Publication
(10) Pub. No.: US 2014/0316937 A1
(43) Pub. Date: Oct. 23, 2014

(54) DIGITAL SYSTEM FOR GIVING A REAL GIFT

(71) Applicants: Anne JIAO, Beechwood, OH (US); Valeri CHIROKOV, Orange Village, OH (US)

(72) Inventors: Anne JIAO, Beechwood, OH (US); Valeri CHIROKOV, Orange Village, OH (US)

(21) Appl. No.: 14/251,413

(22) Filed: Apr. 11, 2014

Related U.S. Application Data
(60) Provisional application No. 61/813,957, filed on Apr. 19, 2013.
(60) Provisional application No. 61/868,670, filed on Aug. 22, 2013.

(51) Int. Cl. G06Q 30/06

(52) U.S. Cl. CPC G06Q 30/0643
USPC 705/26.8

(57) ABSTRACT

A computer-implemented method, comprising a method or touchscreen keyboard method to provide a Gift Character which is defined as a) an image or moving image which attaches monetary value corresponding to a real redeemable gift, b) an image or moving image which communicate visually the intrinsic and emotional value of a gift for electronic messages and documents.

### CROSS-REFERENCES TO RELATED APPLICATIONS

This application claims the benefit of U.S. Provisional Application 61/813,957, filed Apr. 19, 2013 and U.S. Provisional Application 61/868,670, filed Aug. 22, 2013; the disclosures of each of which are incorporated herein by reference.

### TECHNICAL FIELD

The present invention relates generally to a method of providing a gift using a communication network and, more particularly a graphical user interface, the Gift Keyboard, in entering and sending a Gift Character defined as a still or moving gift image redeemable for the real gift, defined as any physical, tangible gift such as a cup of coffee and anything with monetary value, using a communication network, which transmit and receive the gift image or moving images with attached monetary value corresponding to the real gift to be redeemed by the gift recipient at the merchant register.

### BACKGROUND

There are several known systems to purchase and distribute gifts and gift cards using digital computer and the transmission of data. There are a variety of native and web gifting and shopping apps with myriad Graphical User Interfaces (GUI) that allow a gift giver to choose, purchase, and send a gift to a gift recipient. Many conventional user interfaces for gifting and shopping apps must integrate with social networks to access contacts when sending a gift to the recipient via web. Sending a thoughtful gift at times extended planning including further communication and exchanges over calls, messages or emails between friends that is needed to pinpoint the friend's location, situation, and occasion so that the gift is able to bring more utility or satisfaction to the gift recipient. When coupled with the time consuming requirements of searching through databases of gift registries or store menus, skimming through thousands of stores with thousands of products with various pricing—such assault of infinite choice in finding a gift is frustrating and cumbersome to most users.

As portable electronic devices become more compact and online inventory becomes more flooded, searching and picking out a gift easily has become a significant challenge. It has furthermore, become a significant challenge to design a user interface that allows users to easily interact with a multifunction device. Most gifting and shopping apps have resorted to increasingly complex push buttons, complicated key sequences, and menu hierarchies that must be memorized by the user. This situation is unfortunate because the time and thought the gift giver spends on picking out a gift is lost on the gift recipient.

In a related aspect, other native and web gifting apps attempt to simplify the gift giving process by facilitating a monetary exchange between its users. Because gift giving is traditionally motivated by attempting to establish goodwill amongst its participants, giving money or transacting cash can feel emotionally devoid of thought, offsetting some positive benefits in the gesture of gift giving. As an example, a person who comes to Thanksgiving dinner where all parties should contribute a gift of a dish or dessert comes instead with a check or cash for fifty dollars. His action could add insult rather than compliment to the event, which reverses the positive benefits that is supposed to come out of gift giving. Furthermore, a person running late to a meeting at a coffee shop and wants to apologize for his lateness is likely to offer his friend a coffee rather than cash.

Accordingly, there is a need for portable electronic devices including but not exclusively, cellphones, computers, tablets, etc. especially with touch screen displays that have more transparent and efficient user interfaces for expressing intrinsic value, communicating good will through a real purchase of a gift through the portable device. Such interfaces allow tasks involving giving a gift to be performed faster and more efficiently by users, thereby physically conserving power and increasing time between battery charges in portable electronic devices and emotionally allowing gift givers to give more and maintain more salubrious professional and personal relationships.

### SUMMARY OF INVENTION

Disclosed herein is a method, system and graphical user interface for providing a gift instantly via digital computer and transmission of data. The present invention includes a) providing the gift giver with a selection of still or moving gift images redeemable for a real gift which hold intrinsic value (herein referred to as a Gift Character); b) a graphical user interface that organizes gift images redeemable for a real gift which eliminates search time for the gift giver (herein referred to as Gift Keyboard); c) system by which gift giver can select, purchase, confirm purchase, and deliver gift to gift recipient instantly via text, email, or other digital methods; d) system by which the gift recipient can redeem the real gift by presenting the gift image with digital code or encryption on the back of the gift image for the real gift; e) system by which merchant redeems payment via third party payment platform by scanning or reading digital code.

The present invention solves the problems in the prior art by providing a Gift Keyboard, a graphical user interface that allows users to enter and deliver a meaningful gift instantaneously with fewer keystrokes. The present invention comprises a Gift Keyboard for entering and delivering a gift image or moving image attached to corresponding monetary value of respective gift represented by the gift image or moving image. The present invention comprises a Gift Keyboard for entering and delivering a gift image or moving image attached to corresponding monetary value of respective gift represented by the gift image or moving image and method to attach such image with intrinsic (meaning) and extrinsic (monetary amount) value directly to a text message, email, or other form of communication platform with a select series of gestures on a touch screen keyboard display area. The present invention also comprises a Gift Character that refers to a still or animated picture character that is not a text character in written human languages, which holds a respective monetary value of a corresponding real gift.

In one general aspect, a user who has downloaded the application on the user's portable electronic device is presented with the activation of a Gift Keyboard. In accordance with some embodiments, a computer-implemented method is performed at a portable electronic device with a touch screen display or at a fixed electronic device such as but not exclusive to a desktop computer, kiosk, or sales booth. The computer-implemented method includes simultaneously displaying a character input area operable to display text character input and Gift Character input selected by a user, a keyboard display area, a plurality of Gift Character icons, and a plurality of gift category text characters and Gift Characters. As used in the specification and claims, text characters refer to alphanumeric characters, sinographs, Japanese kanji or kana symbols, and/or other written human language characters. As used in the specification and claims, Gift Characters refer to still and animated picture characters that are not text characters in written human languages that hold a respective monetary value of a corresponding real gift. The gift category characters correspond to a plurality of gift categories. In a related aspect, the Gift Character categories may correspond to a small, medium, and large gift—thereby referring to a plurality of gift prices. The computer implemented method also includes detecting a gesture on a respective gift price category; and in response to detecting the gesture on the respective gift price category, simultaneously displaying: a first subset of Gift Characters for the respective gift price category in the keyboard display area, wherein the respective gift price category contains a number of subsets of Gift Characters that correspond to the monetary value of the real gift displayed by the Gift Character.

Each Gift Character provides and transmits information about the gift or product as well as the actual monetary value redeemable by the gift recipient. While displaying the first subset of Gift Character for the respective Gift Character price category in the keyboard display area, the computer-implemented method also includes a detecting gesture in the keyboard display area; and in response to detecting the gesture in the keyboard display area: replacing display of the first subset of Gift Character for the respective Gift Character category with display of a second subset of Gift Characters for the respective Gift Character category that may refer to a plurality of prices.

According to one aspect of the invention of the Gift Keyboard, after the user clicks on the Gift Character, the depiction of the Gift Character or its background is altered to indicate the state of the system, that the Gift Character is selected and ready for purchase. In a related aspect of the invention, the Gift Character that the gift giver selects may be displayed in Gift Keyboard's character input area to confirm that the Gift Character has been inputted into the message as a direct mode of communication.

In accordance with another aspect of the invention, the Gift Keyboard confirms a desire on the gift giver's side to purchase the gift indicated by the Gift Character for a selected contact through pressing a send button as one would when sending any text message or emoticon. According to a related aspect, when the gift giver presses send button, the invention allows for an in-screen pop up confirmation to confirm that the gift giver is notified of the gift price and that the amount will be charged to a form of payment. Unlike previously mentioned shopping pages including Amazon, Square, Gratafy and Wrapp, the user is never taken into another page to complete the purchase but rather confirmed through their normal mode of communication, which reduces keystrokes and simplifies their checkout process.

Upon the gift giver's first purchase of a Gift Character, in one embodiment, the invention will prompt the entering of payment method, which may include but is not exclusive to payment through credit card, payment through payment platform account (i.e. Paypal or Dwolla), or payment through bank account transfer. In a related aspect, the invention will prompt whether the gift giver would like to save payment information for faster future purchases. If the gift giver consents, the invention will save the payment information in a database thus allowing for purchases to be made in a single confirmation via the send button.

In another aspect, the gift giver may also give a gift to multiple friends with one single confirmation via the send button for easier check out. The gift giver may choose multiple contacts from his imported contacts from, but not limited to, his phone directory or social network accounts, and choose to send a gift to those multiple contacts. When the gift giver presses the send button, the invention allows for an in-screen pop up confirmation to confirm the total lump sum price of the gift to multiple contacts.

In accordance with another aspect of the invention, the gift recipient receives the Gift Character through SMS, MMS, or other forms of digital communication including but not limited to email, social networking sites, private or direct messages on discussion boards, etc. The gift recipient may in one embodiment, click on the Gift Character that the gift giver has sent. In one embodiment, if the gift recipient does not have the application downloaded onto the gift recipient's portable electronic device, clicking the Gift Character activates a prompt to download the application from the online application store. In another embodiment, once the gift recipient has downloaded the application from the online application store, the gift recipient may click on the Gift Character again to reveal the value attached to the Gift Character. In another embodiment, after first download of the application store has been completed, the gift recipient may click on any subsequent Gift Character the gift recipient receives and be taken directly to the application—in other words, that clicking on the Gift Character initiates the application redeem process.

Upon receipt of the Gift Character, and upon clicking the Gift Character, invention may prompt the gift recipient for the gift recipient's location. In a related embodiment, once the gift recipient allows location data to be taken from the gift recipient's portable electronic device, merchant locations which accept payment through Prezto (the company providing the service) or other payment providers and which offer the gift indicated by the Gift Character will appear in order of proximity or a function of proximity of gift recipient's location. Gift Characters may include are not excluded to cups of coffee, lattes, iced teas, scones, baked goods, cupcakes, muffins, croissants, ice cream, milk shakes, frozen yogurt, chocolate bars, chocolate truffles, cookies, brownies, rice crispy treats, cinnamon cake, pies, lunch items, bowls of soup, salad, burritos, burgers, fries, sushi platters, charcuterie platters, appetizers, nachos, slushies, hot chocolate, frozen custard, noodles, spaghetti, pasta, breadsticks, and other food items.

Gift Characters may include other tangible items or goods such as clothing, furniture, flowers, appliances, decorative art, electronics, accessories, office supplies, gas which may include but are not excluded to dresses, skirts, pants, shirts, hats, makeup, handbags, kitchenware, couches, T.V.s, blenders, pottery, paintings, prints, headphones, lamps, rugs, and other frequently gifted items for significant occasions such as weddings.

Gift Characters may also include symbolic representations of services or experiences including but not excluded to redeemable movie tickets, music concert tickets, manicures, pedicures, massages, car services, make up consultancies, airline tickets, hotel rooms or stays, painting lessons, piano lessons, educational opportunities, vacation rentals, car rentals, bike rentals, recreational tickets, snowboard lift tickets, sports tickets, and other experience related gifts.

Gift Characters may also include multiple redemptions. For example, a single Gift Character attached to a public social media website where there may be multiple and unpredictable amount of gift recipients could click on a Gift Character. The gift giver may set a limit on total amount of free items to give away per Gift Character, and total price limit on total gifts. For example, a gift giver may buy one hundred, three-dollar ice cream cones and sets the rules to be so that the first one hundred people to see the deal and click on the Gift Character are able to redeem that gift instantly. Gift givers may include sponsors, merchants, corporations, and other large enterprise buyers.

Once the gift recipient chooses the merchant location, the invention generates a code or unique identifier number (e.g. bar code, QR code, NFC, or sound signature), which the gift recipient presents at the merchant terminal. The merchant terminal include but are not excluded to any brick and mortar store, kiosk, stand, vending machine, or individual with access to a portable electronic device or fixed device and sells goods or services. Merchants may sell food and drink items, clothes, furniture or services and experience related goods including but not excluded to spa treatment, film experiences, music experiences, etc.

The merchant terminal uses a method to read the unique identifier number and passes user information, merchant identifier, purchase and payment information to Prezto servers. The merchant terminal may in one embodiment use a portable electronic device such as a smartphone, cellphone, tablet, scanner, reader to scan the code encrypted with the transaction and payment information. In one aspect, the code is read and passed onto the Prezto servers as an automatic bill for the gift recipient's purchase. In one aspect, the Prezto servers will pay the bill through an online payment provider, ACH transaction, bank transfer, sending a check to the appropriate merchant, or any other method that allows Prezto to reconcile the gift with the merchant at which the gift giver has redeemed the gift. In another aspect, the code may contain direct credit card information in the form of a baby credit card number wherein the merchant terminal directly receives the payment from a payment provider such as Visa, MasterCard, American Express or Discover.

The subject matter described herein can be implemented to realize one or more of the following advantages. Merchants may be able to deliver real gifts via mobile networks (e.g. cellular networks, wireless networks) using carrier-agnostic technology (e.g., Short Message Service/Multimedia Messaging Service or other delivery methods). Merchants (e.g. Starbucks, McDonalds) may be able to advertise specific, unique and branded products and deliver product and gift information. Gift givers may give real gifts to gift recipients that deliver intrinsic sentiment, maintains social etiquette while also delivering tangible and monetary value.

The invention comprises a computer-implemented system that uses a processor, an interface and memory storing instructions to display content and accept user input to implement via a computing device, an executable application to provide a gift selected from a set of pre-determined gifts to a known person by executing the application via a computing device; a group of virtual images of gifts associated with the executable application to provide via a display of the computing device, a graphical representation of the gifts including an indication of a purchase price of each gift, the virtual images selectable by the user via the display of the computing device to trigger the executable application to select that gift for the known person; a purchase module that communicates with a merchant to receive and process a request to purchase and pay for the gift via the interface, the gift funded by a user and available at a location of the merchant; and a delivery module that communicates with a computing device of the known person, the delivery module creating a virtual image of the gift on the computing device of the known person, the virtual image comprising a code useable by the merchant to provide the gift to the known person, the virtual image of the gift not including a purchase price of the gift. When the known person presents the code to the merchant, the merchant delivers the gift to the known person.

In an embodiment, the user adds other known persons to receive the gift. in another embodiment, the location of the merchant and the proximity of the merchant to the known person is communicated to the known person simultaneously with the gift. In yet another embodiment, a message transmitted from the user to the known person with the virtual image. In an additional embodiment, the graphical representation comprises an image of an item available at the merchant's location. In an embodiment, the computing device is a mobile device.

The present invention is a tangible computer readable storage medium including program code for execution by a processor. The program code, when implemented, is to provide: an executable application to provide a gift selected from a set of pre-determined gifts to a known person by executing the application via a computing device; a group of virtual images of gifts associated with the executable application to provide, via a display of the computing device, a graphical representation including indication of a purchase price of the gifts. The virtual image selectable by the user to trigger the executable application via the display of the computing device. The application: i) communicating with a computing device of a merchant to receive and process a request to purchase and pay for the gift, the gift funded by a user and available at a location of the merchant, and ii) communicating with a computing device of the known person to provide a virtual image of the gift to a computing device of the known person, the virtual image comprising a code useable by the merchant to provide the gift to the known person, the virtual image of the gift not including a purchase price of the gift, and wherein, when the known person presents the code to the merchant, the merchant delivers the gift to the known person. The processor accepting a push of information from: x) the merchant regarding available gifts, and y) payment processing means, and providing acknowledgement to the user of delivery of the gift to the known person.

In an embodiment, the a user activates a program on a computer. The program is an executable application which brings up a Gift Keyboard or collection of Gift Characters which are defined as: a) an image or moving image which attaches monetary value corresponding to a real redeemable gift, b) an image or moving image which communicate visually the intrinsic and emotional value of a gift for electronic messages and documents. The user selects a Gift Character using an exemplary user interface of Gift Character categories that narrow down Gift Character choice in a faster, more organized manner, and the user inserting the Gift Character into a delivery module that communicates with a computing device of a known person using electronic messages and documents including but not excluded to email, SMS/MMS or posting on a social media website for redemption such as Twitter, Facebook, Instagram and other communication methods. The user confirms the intent of purchasing the Gift Character by pressing a delivery mechanism such as “send”. The user confirms the total purchase of the Gift Character through agreement with a purchase module of total price and total recipients of the Gift Character through a pop up banner or push notification and pressing “confirm”. Thereupon, he electronic deliverer of gifts charges the user for the total purchase of the Gift Character or Characters including a delivery fee and delivering that Gift Character to the known person. The known person receives the Gift Character using a computing device, which can be portable or a fixed electronic device. The known person initiates redemption of the real gift using the Gift Character by presenting the virtual image, which may include a code, to the merchant and the merchant delivers the gift to the known person. The merchant charges or bills the electronic Gift Character deliverer for redeemed gift. The electronic Gift Character deliverer reconciles the bill through manual or automatic payout through a payment provider, check, bitcoin, or any other form of current or future payment.

In an embodiment, the method includes a copy and paste method to copy a Gift Character from the Gift Keyboard or collection of gift images and paste the Gift Character in an electronic document format outside of the executable application including email, SMS/MMS or posting on a social media website for redemption such as Twitter, Facebook, Instagram and others.

In an embodiment, the method includes an organizational method of Gift Characters which reduces clutter and gift giver search time by organizing Gift Characters into variable Gift Character categories including but not exclusive to a) price of gift, b) store location, c) geographic location, d) rarity, e) merchant preference, f) customer popularity or g) by various other methods of separating and picking a gift or item.

In an embodiment, the Gift Character categories include separating the category into one or more subsets of Gift Character categories. For example, if the variable factor is the price of the gift, the Gift Character categories can be broken down into one or more gift price buckets to include only gifts under the subsets of Gift Character categories such as $3, $6 or $12 price points, which can be used as a sorting tool.

In an embodiment, selection of Gift Character is indicated by visual or audio or other modification of the Gift Character including but not excluding a) color and shape of Gift Character background, b) sound or music to indicate selection, c) movement or animation of Gift Character.

In an embodiment, the gift giver may select a Gift Character and add other known persons to receive the gift in one message within the executable app.

In an embodiment, the gift giver activates a confirmation key such as the “Send” button on the Gift Keyboard, which activates a confirmation purchase message that includes but is not exclusive to: a) a text bubble, or b) a text banner which confirms the exact price of total purchase, including the calculation of multiple gift recipients and multiple Gift Characters in a message.

In an embodiment, the invention delivers a Gift Character from the first user terminal (gift giver) to a second user terminal (gift recipient) via the executable application or through SMS, MMS, email, social networks, or electronic documents via a portable electronic device outside of the executable application.

In an embodiment, the clicking on the Gift Character via a portable electronic device may activate a link to the application distribution store to download the application in order to redeem the intrinsic value and monetary value of the gift. in an alternate embodiment, clicking on the Gift Character via a portable electronic device activates the application on the gift recipient's portable electronic device if the application is already installed on the gift recipient's computing device.

In an embodiment, the known person clicks on the Gift Character which activates a list or map of merchant locations prompted by various factors including but not exclusive to location a) distance, b) customer preference of location from gathered historical data, or c) merchant advertising giving the known person the choice of where and when and details of gift redemption based on product information provided to the known person of the gift including but not exclusive to: a) size, b) price, c) brand to the Gift Character via SMS/MMS, e-mail and other online delivery methods.

In an embodiment, the known person may activate interactive, gamification effects and merchant advertising on the receiver terminal from the attached Gift Character through the process of gift redemption.

In an embodiment, the merchant is not signed up for the application and receives payment or gift payout directly from the gift giver using an instant form of payment including but not excluded to a baby credit card or bitcoin. In an alternate embodiment, the merchant is signed up for the application and scans or inputs an encrypted code that begins the pay out process for the specific gift redeemed. The code may be a) a bar code, b) QR code, c) NFC, or d) sound signature or e) any similar linking mechanism. The encrypted code transmits transaction information including but not exclusive to a) contact name, b) transaction history, c) price of gift, c) gift item redeemed, d) date and time of redemption, e) amount merchant scanned for.

In an embodiment, the merchant is paid out by a third party via methods including but not excluded to a) check, b) third party payment platform, c) credit card or baby credit card number.

An advantage of the present invention is that user growth is implemented through inherent incentive for App download via the retrieval of a gift sent by a trusted contact. The user imports known persons from contacts existing in the user's digital phone book residing on a computing device, directly inputting from personal record systems such as an address book, or social networking channels. The user selects a Gift Character appropriate for the occasion wherein the Gift Character may have extra meaning or intrinsic, symbolic value to the known person. The system detects whether the known person whom the user is sending the Gift Character has an account registered to the system so that executable application must be downloaded. The system detects that the known person does not have executable application installed on the known person's computing device, sending a downloadable link along with materials including but not excluded to Gift Character, gift image with symbolic value, visual representation of a real gift, 3D hologram, interactive images, effects and games, instructions to download, promotional messages, video, and others to entice the known person to click the link to download the executable application.

In an embodiment, the known person downloads the executable application motivated by the intrinsic reward aspect of the gift of not letting user or gift giver's money go to waste, or of maintaining intrinsic feeling of friendship and good will. Alternately, the known person downloads the executable application motivated by the extrinsic or monetary reward aspect of the gift. The known person becomes a gift giver through download of the app and prompting of their friend's occasion.

In an embodiment, the system tracks user actions on giving and receiving gifts on a computing device including but not excluded to these details of the gifts: a) time, b) amount, c) occasion, d) gift item, e) whether the Gift Character was redeemed for the gift that was intended by the gift giver, f) times a particular gift has been given, or g) frequency of giving a different gift. The system utilizes already existing knowledge and relationships that a gift giver has with the gift recipient to send a gift that the gift recipient is more likely to redeem because of intangible and intrinsic qualities that may be expressed through the gift. The system manages trusted contacts based on referrals that may comprise of a system or algorithm to analyze a trust score between two contacts based on history of giving gifts to be used to give better recommendations or more meaningful gifts on next use. The invention detects whether the gift giver's intended gift recipient has already downloaded the gift giving application and upon detection, sends the gift recipient 1) a download link via a Gift Character prompting the gift recipient to download the App in order to redeem the actual gift the gift giver has sent the gift recipient if the recipient has not yet downloaded the App onto his mobile phone or portable electronic device; and 2) a Gift Character of the gift that the gift giver has sent the gift recipient as well as the encrypted code that allows the gift recipient to retrieve the actual gift from a merchant.

The system projects growth predicting user growth in the short term based off of historical data as well as a population growth model.

As used herein, “approximately” means within plus or minus 25% of the term it qualifies. The term “about” means between 1/2 and 2 times the term it qualifies.

The compositions and methods of the present invention can comprise, consist of, or consist essentially of the essential elements and limitations of the invention described herein, as well as any additional or optional ingredients, components, or limitations described herein or otherwise useful in compositions and methods of the general type as described herein.

Numerical ranges as used herein are intended to include every number and subset of numbers contained within that range, whether specifically disclosed or not. Further, these numerical ranges should be construed as providing support for a claim directed to any number or subset of numbers in that range or to be limited to the exact conversion to a different measuring system, such, but not limited to, as between inches and millimeters.

All references to singular characteristics or limitations of the present invention shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

Terms such as “top,” “bottom,” “right,” “left,” “above”, “under”, “side” “front”, “below” “upper”, “back” and the like, are words of convenience and are not to be construed as limiting.

### BRIEF DESCRIPTIONS OF THE SEVERAL VIEW OF THE DRAWINGS

FIG. 1 is a block diagram of a system for the exchange of a Gift Character of a product for the physical product that includes the gift giver's mobile phone, the Prezto server, a payment gateway, payment provider, gift recipient's mobile phone and the merchant.

FIG. 1a is an alternate block diagram with more detail between Gift giver, Gift recipient, Merchant and Prezto.

FIG. 2 illustrates a text message conversation on a portable electronic device equipped with a touch-sensitive display in accordance with some embodiments.

FIG. 3A illustrates exemplary user interfaces for providing and organizing Gift Characters in a Gift Keyboard on a portable electronic device equipped with a touch-sensitive display in accordance with some embodiments,

FIGS. 3A-E illustrates exemplary user interfaces for navigating between Gift Character subsets in a particular Gift Character category and inputting a Gift Character on a portable electronic device equipped with a touch-sensitive display in accordance to some embodiments.

FIG. 4 illustrates user selection of gift and change in system using background color indicator.

FIG. 4A illustrates user specifying selection interface of a branded merchant item of a specific product.

FIG. 5 illustrates a push notification of a gift purchase confirmation of total price of gift purchase.

FIG. 5A illustrates a push notification of a gift purchase confirmation of the total price of a gift purchase for multiple users.

FIG. 6 illustrates exemplary user interface for sending a Gift Character on the gift giver's terminal.

FIG. 7 illustrates exemplary user interface for receiving a Gift Character on the gift recipient's terminal.

FIG. 8 illustrates exemplary user interfaces for prompting gift recipient to allow access to their location data from clicking on the Gift Character.

FIG. 8a illustrates one embodiment of listing merchant locations for gift recipient's redemption convenience.

FIG. 9 illustrates QR code on the “back” of Gift Character to be redeemed for gift at merchant location.

FIG. 10 illustrates one embodiment of digital content when activating the Gift Character.

FIG. 11 illustrates sample social network of an online user.

FIG. 12 illustrates a sample social network including multiple interconnected users.

FIG. 13 illustrates a table of a sample app's growth through digital content redemption.

FIG. 14 illustrates a graph of a sample app's exponential App growth over 12 months.

FIG. 15 illustrates logarithmic growth model vs. actual app download growth.

FIG. 16 illustrates a graph of projected App users using the gift redemption model.

FIG. 17 illustrates a technology block diagram of the adoption cascade process from one user to the next.

FIG. 18 illustrates a technology block diagram of gift giving system when integrated with merchant POS system.

### DETAILED DESCRIPTION OF THE INVENTION

The deficiencies described in the related art and other problems associated with user interfaces for finding and sending a gift that is instantly redeemable by the gift recipient via portable devices are reduced by the disclosed invention. In some embodiments, the device has a touch sensitive display (also known as a “touch screen”) with a graphical user interface (GUI), one or more processors, memory and one or more modules, programs or sets of instructions stored in the memory, or cloud, or other internet accessible storage for performing multiple functions. In some embodiments the user interacts with the GUI primarily through finger contacts and gestures on the touch-sensitive display. In some embodiments, the functions may include telephoning, video conferencing, emailing, instant messaging, social networking on web based or non-web based sites such as Facebook, Twitter, Instagram, Dropbox, Snapchat, Google, and other data or document sharing sites.

In accordance with some embodiments, a computer-implemented method is performed at a portable electronic device with a touch screen display. The computer-implemented method is a way to effectively translate monetary value to perceived intrinsic inherent value of gifts across the web. The computer implemented method includes simultaneously displaying a gift input area operable to display text character input and Gift Character input as selected by a user, a keyboard display area and a plurality of Gift Characters. The Gift Character categories correspond to a small, medium, and large gift—thereby referring to a plurality of gift prices. The computer-implemented method also includes detecting a gesture on a respective gift price category; and in response to detecting the gesture on the respective gift price category, simultaneously displaying: a first subset of Gift Characters in the keyboard display area, wherein the respective gift price category contains a number of subsets of Gift Characters that correspond to the monetary value of the real gift displayed by the Gift Character. Each Gift Character provides and transmits information about the gift or product as well as the actual monetary value redeemable by the gift recipient. While displaying the first subset of Gift Character for the respective Gift Character price category in the keyboard display area, the computer implemented method also includes detecting a gesture in the keyboard display area; and in response to detecting the gesture in the keyboard display area: replacing display of the first subset of Gift Characters for the respective gift price category with display of a second subset of Gift Character for the respective gift price category.

The current invention comprises a system that provides for the instantaneous delivery of a real gift. The present invention comprises a system for the purchase of a gift, the transmission of a Gift Character of the purchased gift to a gift recipient via wired and wireless systems using a digital code transmitted through the system to physically redeem the Gift Character of the purchased gift for the actual gift.

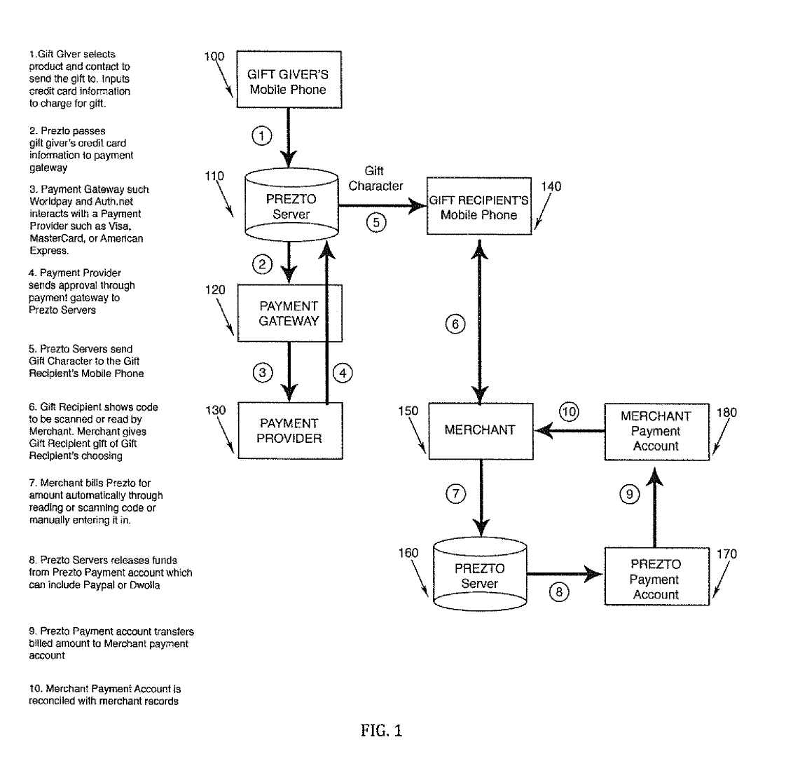

The invention is described as follows: FIG. 1 shows a block diagram of the present invention. The gift giver 100 accesses the gift giving mobile application from the gift giver's portable electronic device. The gift giver integrates contacts from various social networks including from the gift giver's phone book, social network websites such as Facebook, Twitter, Instagram, Foursquare, or email contacts.

The gift giver selects a Gift Character from the Gift Keyboard. In one embodiment, the first time the gift giver makes a purchase, the gift giver will input credit card information into the mobile application. The inputted credit card information will be stored on the smartphone and passed through 110, the Prezto servers. The Prezto servers will pass the credit card information through 120, a payment gateway, and in some embodiments may be through Auth.net, PayFlo Pro or other payment gateway options. The payment gateway, 120, passes payment and purchase information to a payment provider, 130, to authorize the purchase, and in some embodiments will include payment providers such as Visa, Mastercard, or American Express. If the transaction gets approval from the payment provider, 130, the Prezto Servers, 110 will charge the gift giver's credit card for the specific Gift Character, which the gift giver has chosen.

The Prezto Servers, 110, will then deliver the Gift Character containing a code to store monetary value or activate monetary payout to merchants, and in some embodiments may be include a bar code, QR code, RFID, NCR, or sound signature to the gift recipient's portable electronic device, 140. The gift recipient takes the Gift Character up to the Merchant, 150, which may be a website, web application, or native application residing in some embodiments on a portable electronic device or a Merchant point of sale (POS) system to be read. The Merchant, 150, activates, in some embodiments a scanning function to receive information from the code encrypted within or on the “back” of the Gift Character. The “back” of the Gift Character can refer to any action in the GUI that reveals a QR code or other code to be scanned or read. In one embodiment, the “back” of the Gift Character may be revealed with a swipe, tap, click on the Gift Character. From that action, the QR code or other scannable, readable code may reveal itself as the “back” of the Gift Character with a flip, open, appear or other transition effect that brings the code up. In another embodiment, the “back” of the Gift Character may be revealed through a physical detection in the placement of the phone. In one aspect, this may include the motion of placing the phone face down, with the I/O subsystem detecting a motion reading from, in one embodiment, a built in accelerometer. In another aspect it may be a motion gesture made with the phone such as a shake, spin or tap of the physical portable or fixed electronic device. In another embodiment, the Merchant may enter the code into their Prezto account via a website, web application, or native application residing in some embodiments on a potable electronic device or a Merchant point of sale. In one embodiment, the activation of the payment process through scanning the code attached to the Gift Character may include sending billing information of the total amount charged to the gift recipient for the gift recipient's purchased item, merchant id, transaction id, or other information about the transaction to the Prezto servers 160. The Prezto Servers, 160, will, in one embodiment, generate a notification to pay out amount to merchant through a payment provider such as Dwolla. The Prezto Servers will activate the Prezto Dwolla account, 170, to send money instantly into the Merchant's payment provider account or merchant Dwolla account, 180, completing the pay out process between Prezto and the Merchant, and reconciling the gift recipient's redemption of the gift. FIG la explains the technology in a similar way.

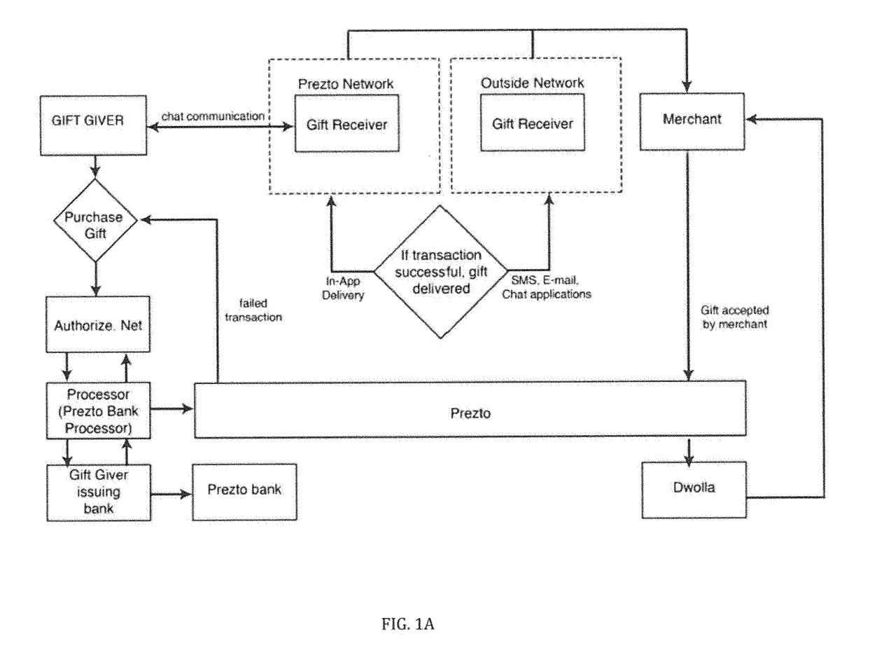

The exemplary interface is defined as follows: FIG. 2 shows a text message conversation that the user is already having with a contact. In this conversation, the use case scenario is a person running late to a meeting at a coffee shop. The user feels guilty and wants to express apology. The user has already texted to say “sorry”.

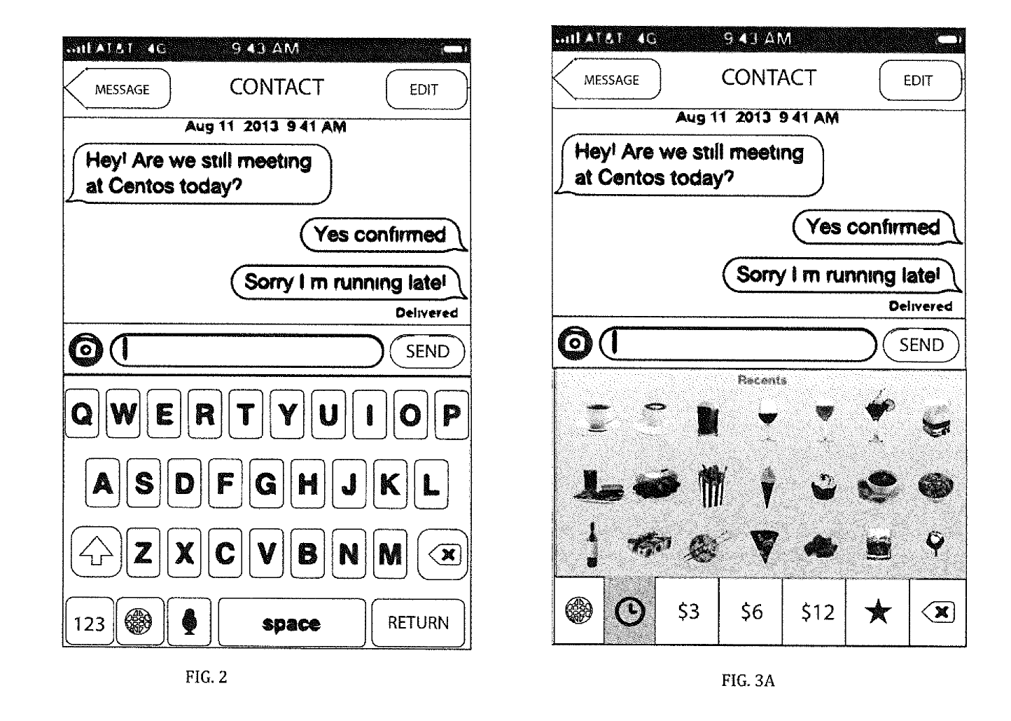

FIG. 3a shows a text-messaging interface wherein the Gift Keyboard is activated on the user's portable electronic device. The Gift Keyboard may be activated through going into an alternate application downloaded on the portable electronic device or through integration with the portable electronic device provider API. The gifts are separated into different Gift Character categories, and in this case are separated through Gift Character price ranges as well as recently bought gifts. The first category shown highlighted in FIG. 3a is the recently bought gifts tab. FIG. 3b shows the second category of Gift Characters—all gifts costing the gift giver at or under the specified Gift Character price category of for example, $3, including examples such as coffee, French fries, a chocolate bar, an ice cream cone, etc. The third category of characters is shown in FIG. 3c which displays gifts that cost at or under $6 including a fancy coffee drink, mug of beer, glass of wine, appetizer, or soup for lunch. The fourth category of Gift Characters is shown in FIG. 3d which displays gifts that cost the gift giver a total of $12 or less which include but are not excluded to a typical lunch such as pizza, salad, or sushi. The last Gift Character category is shown in FIG. 3e, which displays premium gift items that are at a higher price such as a bottle of wine or branded scotch. This category contains exclusive, rare and branded items.

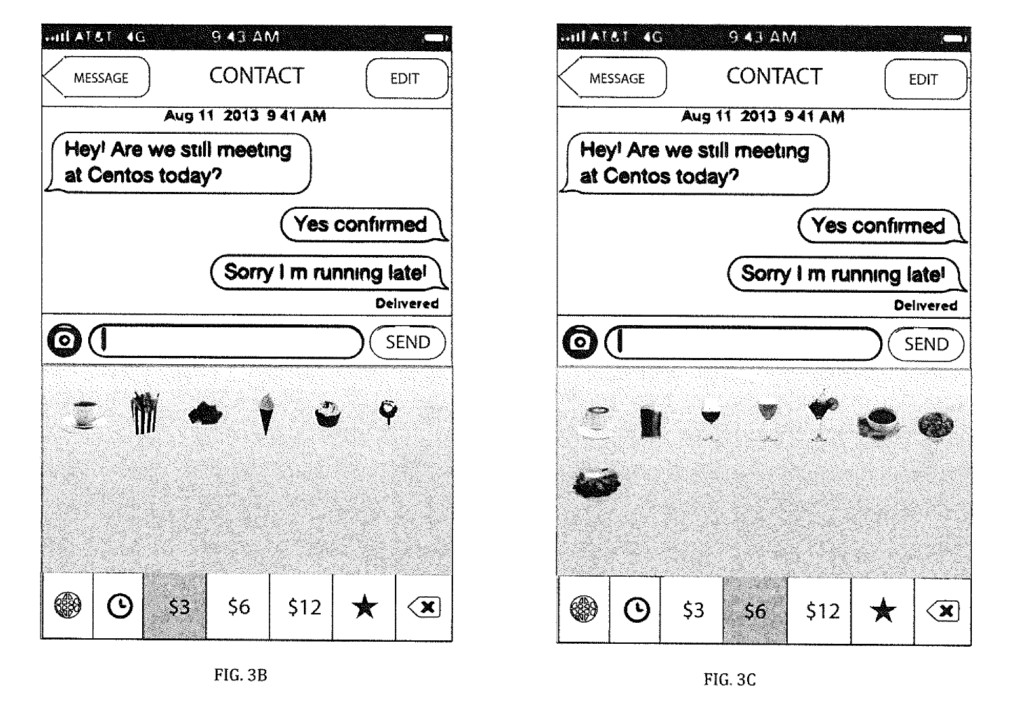

FIG. 4 shows the user inputting a Gift Character from the Gift Keyboard as easily as one would attach an emoticon to a text message. In one aspect of the invention, after the user clicks on the Gift Character, the depiction of the Gift Character or its background is altered to indicate the state of the system, that the Gift Character is selected and ready for purchase. This is shown in FIG. 4 where the example to indicate the state of the system, that the Gift Character is selected and ready for purchase is an altered background of the Gift Character. The gift image is attached to any text message or electronic message. The change in the state of the system in one embodiment can be indicated through a visual effect such as but not excluded to fireworks, glowing background, lightning, rippling, flashing or appearance of the Gift Character in the send box. The change in the state of the system in another embodiment may be a visual effect that is directly upon the Gift Character itself such as but not excluding an animation in which the gift bounces, twirls, glows, flashes, shimmers, glitters, grows or shrinks in size, pulses, lights up, darkens, multiplies, or effect that mimics the item in real life, any chemical or physical change including steaming, burning, cooling down, blooming, bending, stretching, or disappearing through consumption.

FIG. 4A shows the user inputting a more specific Gift Character from the Gift Keyboard. In one aspect of the invention, the user may use a gesture such as holding down upon the Gift Character, and in this case, of an ice cream cone to specify the gift further in order to show more thought to the gift recipient. In one aspect, the gift giver may have knowledge that one ice cream store appeals to the gift recipient more. In another aspect, the merchants with discounts or specials will be prompted with the gift giver's gesture. In another embodiment, the gift giver may specify or customize the item to the gift recipient's tastes such as adding virtual representations of chocolate or a cherry to the Gift Character.

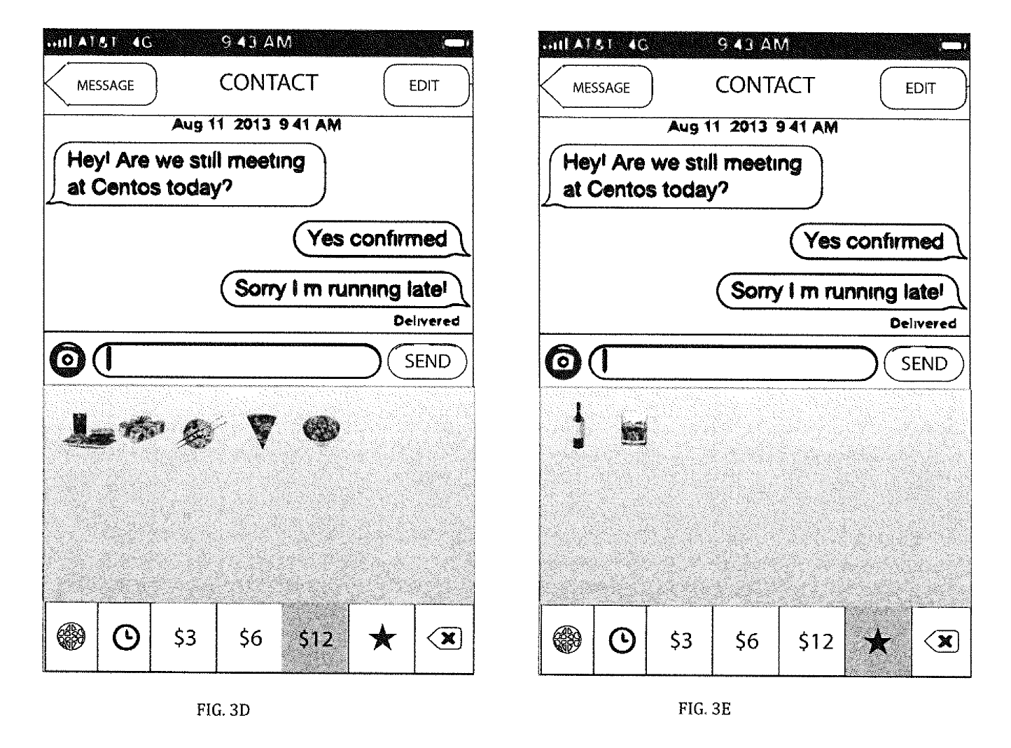

When the gift giver presses the “Send” button, the gift giver will prompt the checkout process. Because of the similarities between sending an emoticon and sending a Gift Character, the gift giver reduces the time spent on learning the hierarches of using the application, saving power on portable electronic devices. The gift giver will receive a push notification, pop up window, or banner, that confirms the price and purchase of the gift the gift giver selects. FIG. 5 shows the gift giver receiving a push notification to confirm the purchase of the Gift Character he has selected. In accordance to another embodiment of the invention in which the gift giver may buy one or more gifts for one or more gift recipients, the push notification, pop-up window or banner may confirm the total price of the complete Gift Character purchase or purchases as shown in FIG. 5a. This confirmation is shown in both FIGS. 5 and 5a wherein the gift giver may agree to the purchaser of the gift by pressing “confirm” and may cancel his purchase by pressing “cancel”.

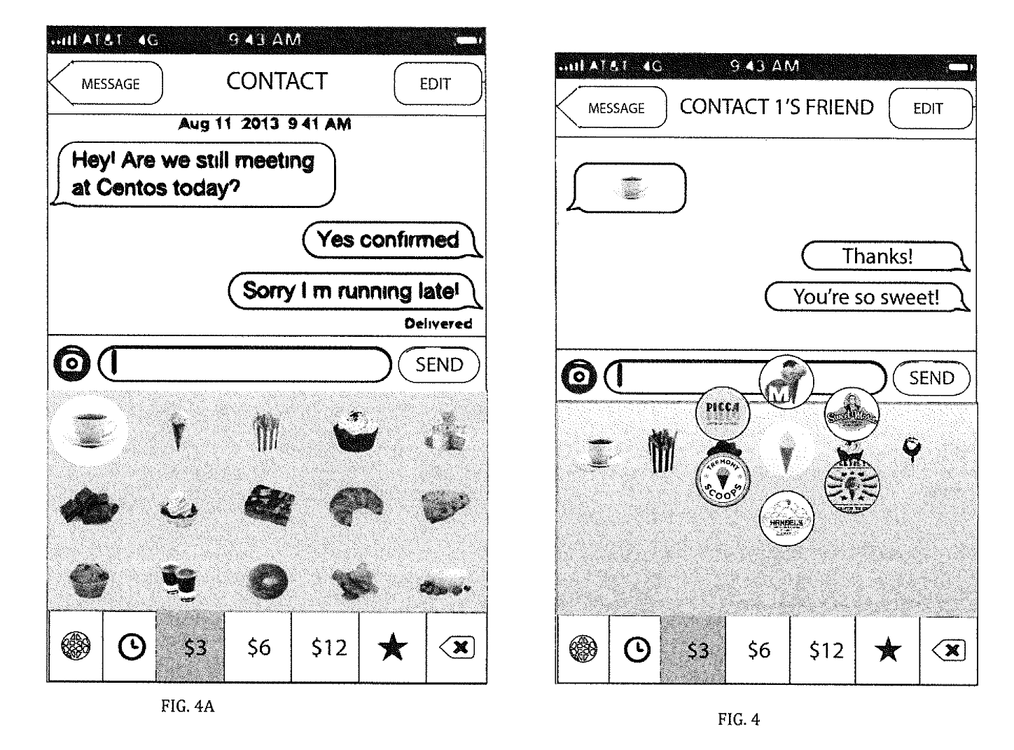

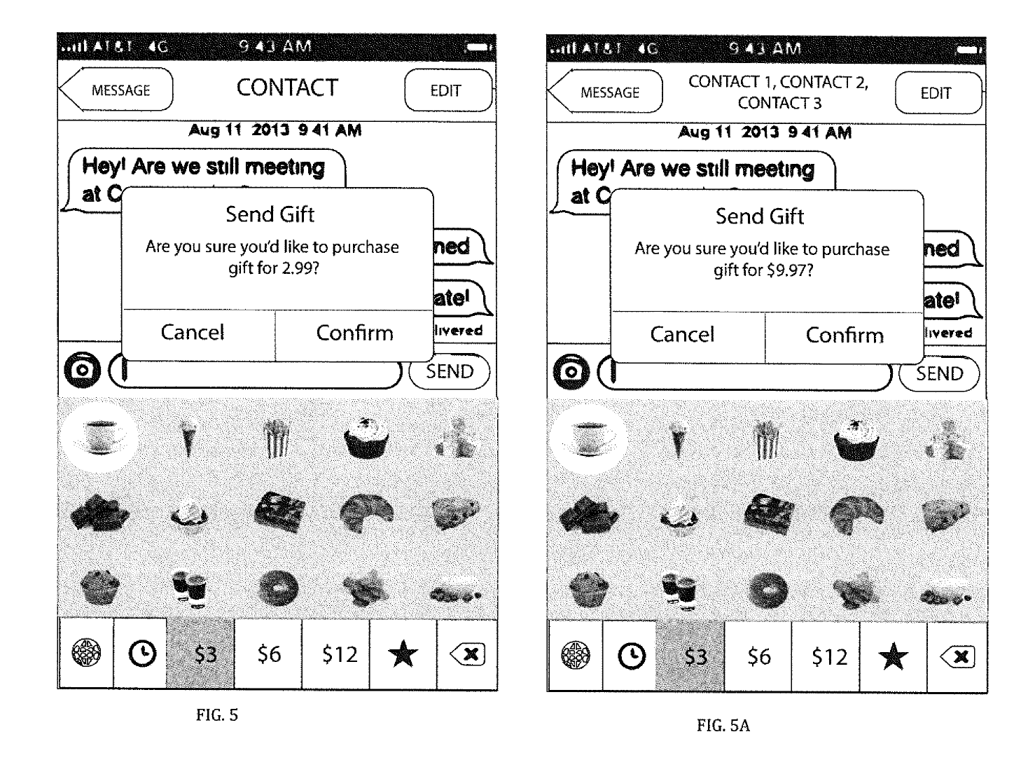

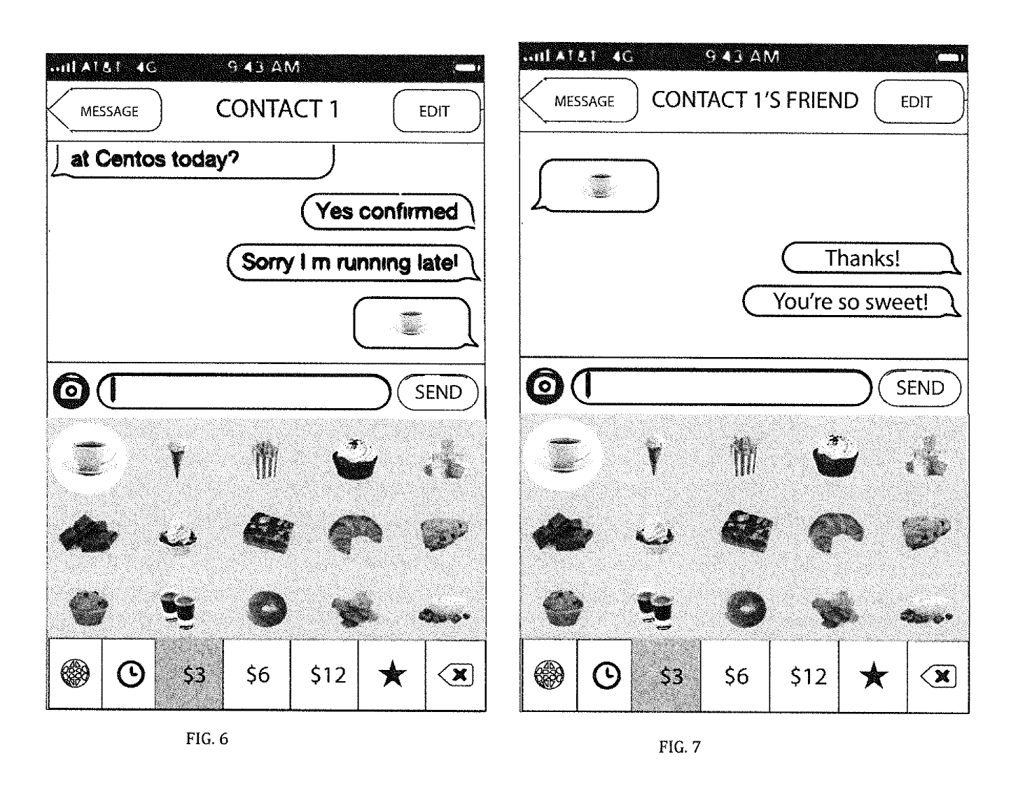

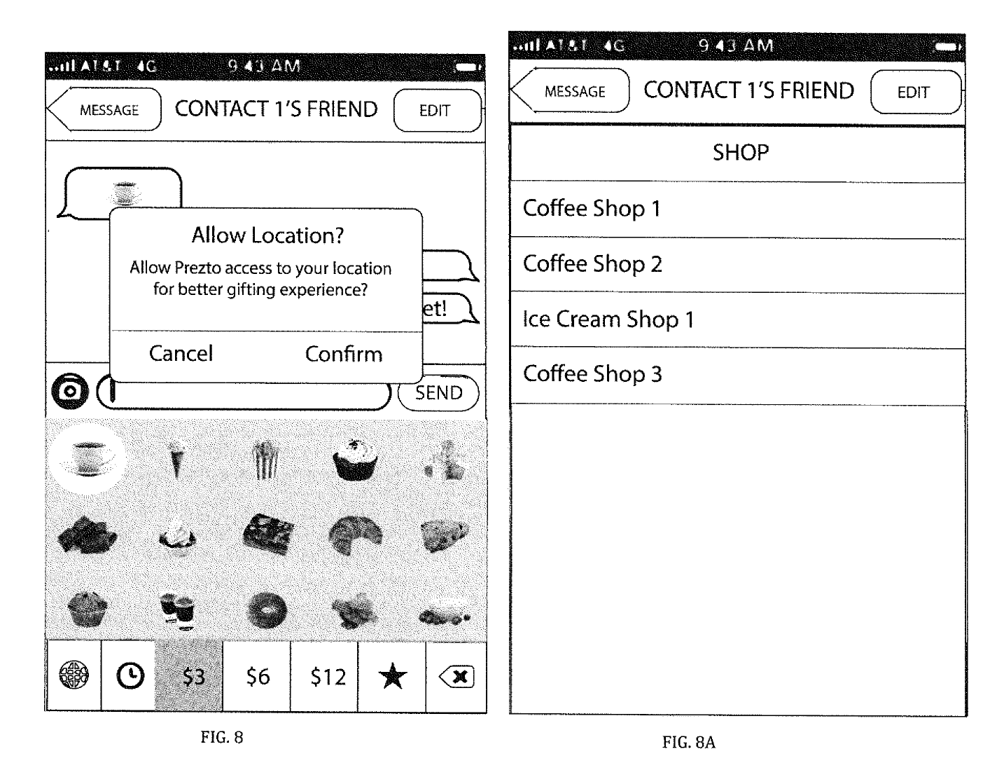

Once the purchase is confirmed, the text message is sent with an image or moving image of the gift to the gift recipient's phone as shown in FIG. 6. The gift recipient receives the image or moving image of the gift on her portable electronic device. FIG. 7 shows the gift recipient's side—which receives that Gift Character instantly via SMS/MMS, email or other social network platforms in electronic message form. When the gift recipient clicks on the Gift Character, the gift recipient will be prompted for their location as shown in FIG. 8. The gift recipient may allow the application access to the gift recipient's location by clicking “allow” and may reject access by pressing “cancel”. Allowing location access will allow the application software to calculate the closest place to redeem the gift that the gift giver has sent. In some embodiments, the information may be shown as a list of merchants ordered by distance away from the gift recipient's location. FIG. 8a shows this location tagging as a list of merchants in which the Gift Character may be redeemed. The merchant listed first will be the closest merchant in which the gift recipient can redeem the gift. The second merchant listed will be the second closest merchant in which the Gift Character is redeemable and so on. In another embodiment, location information can be shown through a map of closest locations to the gift recipient. Clicking on a location will reveal a QR code or other code for the Merchant to scan as shown in FIG. 9.

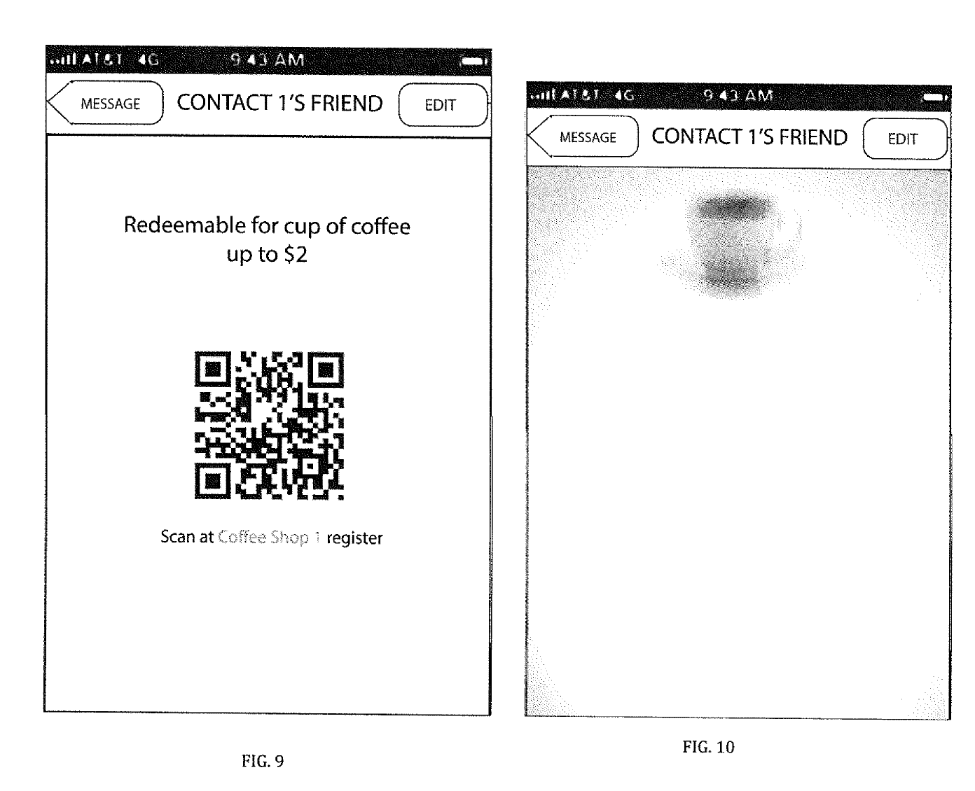

Clicking on the Gift Character also may initiate digital content as shown in FIG. 10. Digital content may include interactive animations that mimic the actual gift, fun video animations, or games that keep the gift recipient occupied. A sample animation includes a GIF image as shown in FIG. 10.

In accordance to some embodiments, a computer-implemented method is performed at a portable electronic device. The computer-implemented method is a way to facilitate the spread of Application downloads residing on a smartphone or portable electronic device. The computer-implemented method includes the gift giver allowing access to his contacts via his smartphone or portable electronic device, picking out a gift for the contact, recording history of gifts sent to a particular contact on an App server, a method of detecting whether the contact has already downloaded the App, sending a download link via a Gift Character, and prompting the user to download the Application in order to redeem the gift that his trusted contact has sent him. The computer-implemented method includes the gift giver choosing a contact based on his existing knowledge of the contact stored in the gift giver's smartphone or portable electronic device. In some embodiments, the computer-implemented method pulls up most trusted contacts utilizing an algorithm for trust based on recent contact history, most recent conversations, most contacted, or favorite categorization in address books.

In some embodiments, the computer-implemented method includes a gift giver picking a gift for the gift recipient. Based on already existing knowledge that the gift giver has on the gift recipient, the gift giver chooses an appropriate Gift Character representing the gift he would like to send. For example, if a gift giver knows that the gift recipient is trying not to drink coffee for a month as a personal goal, the gift giver could make a thoughtful informed decision of inputting the gift of green tea instead. The computer-implemented method will record the information by remembering what the gift giver has sent the gift recipient so that the next time a gift giver chooses the same contact, the gift of green tea may be organized higher than coffee, thereby recording gift giver and gift recipient preferences for simpler, easier gift giving. The gift giver's Gift Character choice shows not only intention behind the transaction of giving a gift, but it also shows the knowledge the gift giver has of the gift recipient, thus increasing the gift recipient's trust and likelihood to redeem the gift.

In some embodiments, the gift recipient may choose a different gift than the Gift Character that the gift giver sent them, For example, once the gift recipient receives the Gift Character of a green tea, he may decide to redeem the Gift Character for a cupcake. In such a case, the computer-implemented method may include recording what the gift recipient redeemed the Gift Character for, so that for a future purchase, the gift giver may be presented with the gift recipient's preferred Gift Character organized higher on the Gift Keyboard, thereby making gift giving simpler and easier.

In some embodiments, the computer-implemented method includes the detection of whether the gift recipient is already signed up with the gifting application residing on the smartphone or portable electronic device. When signing up with the App, a persona registers his phone number to the App. In some embodiments, the computer-implemented method detects whether the gift giver's contact is registered with the App by seeing if the contact number of the gift recipient is registered on its servers. If the gift recipient's number is not registered, the Application sends the Gift Character via text attached to a web link leading the gift recipient to download the Application in order to redeem the gift. The gift recipient may click on the gift image, leading to the download link of the Application. If the gift recipient decides he would like to redeem the gift the gift giver or contact has sent him—based on how much the gift recipient trusts the contact, based on how much the gift recipient wants the gift, based on how much thought the gift recipient thinks his contact has put into the gift—the gift recipient will download the application and be converted as an app user—or gift giver. He may redeem the gift through clicking on the Gift Character again, opening the App to reveal the code, QR code, sound signature, etc. that the gift giver has sent him. If the gift recipient decides not to download the App, he will not be able to redeem the gift the gift giver has sent him.

The projected growth for this App download model utilizing gift redemption and a trust based transaction process follows a Malthusian population growth model whereby the growth rate is modeled after actual App growth motivated by word of mouth. In this particular embodiment, actual App growth motivated by word of mouth is based on historical data on Snapchat's App adoption. In their case, in order for a recipient to receive the sender's content, the recipient must download the App first. While a computer-implemented method of motivating App download through obtaining referred digital content is available, there is not yet a method for motivating App download through obtaining a real gift—or referred product by a friend. However, despite this difference in digital content vs. real gift, our model assumes similar growth rate—using referral and word of mouth advertising.

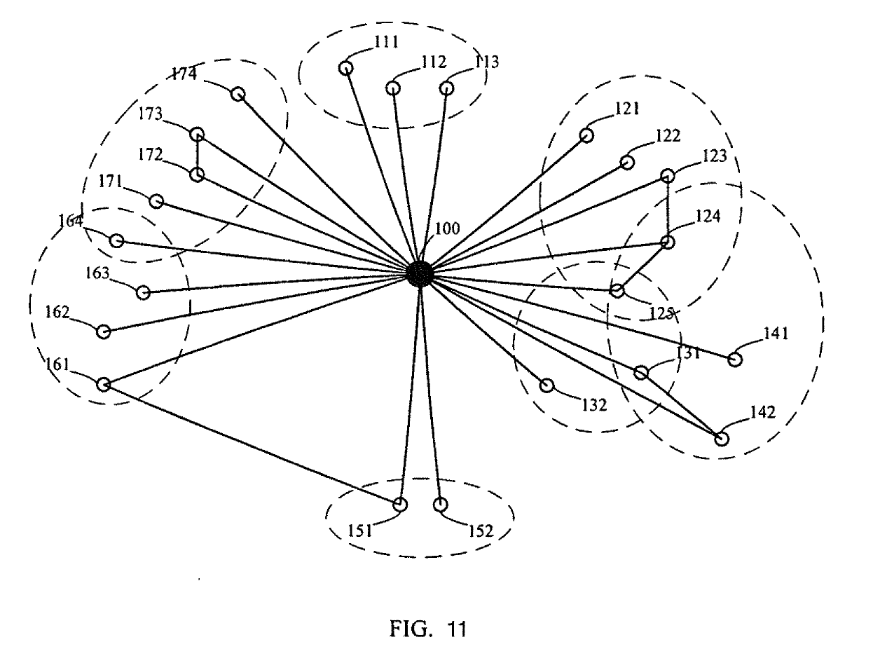

FIG. 11 illustrates a sample social network of an online user. In this example, the user 100 has many contacts, together forming a social network including the user 100. The user's 100 contact information may be obtained in this case through allowing access to the contacts' address book when the contact picks a gift for the contact. For example, contacts 121, 122, 123, 124, and 125 may be found in the contact list of the user's phone book, or login information of a social networking website (such as Facebook or Twitter). Extending the social network of a single user into multiple users, a large social network may be constructed, which includes many individual users that communicate with each other via many different channels.

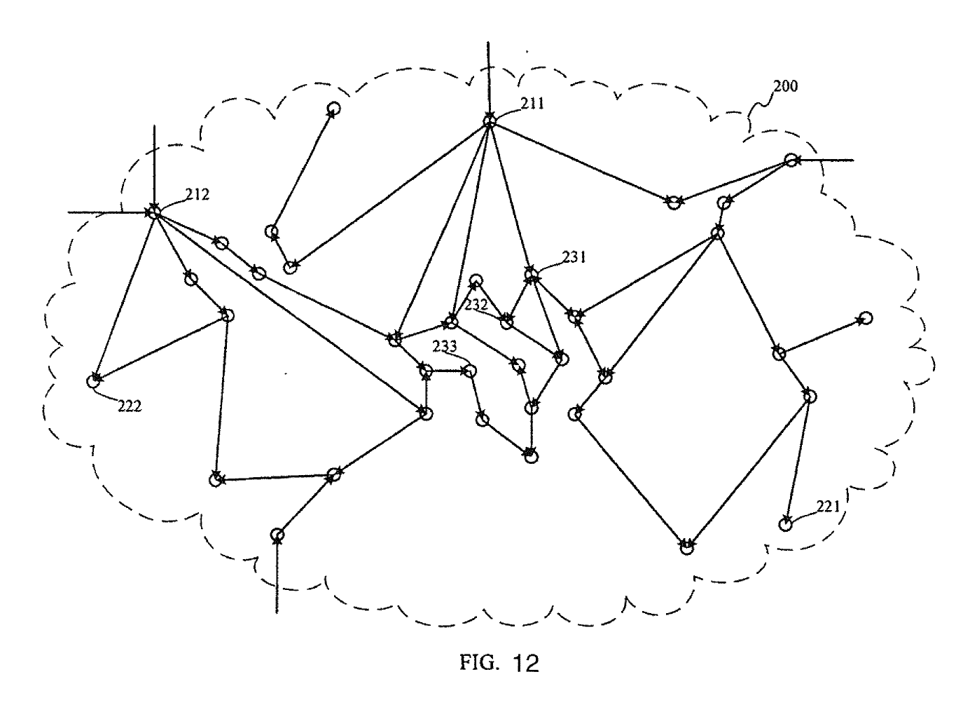

FIG. 12 illustrates a sample social network 200 that includes multiple interconnected users. Each user in the social network 200 is represented by a small circle. A line connecting two users represents some form of contact or tie between the two users. The social network 200 only includes a small number of users for illustrative purpose. In reality, such a social network often includes thousands or hundreds of thousands of interconnected users.

A social network may be further refined to include only users who satisfy certain criteria. For example, a social network may be established to include only users from a particular geographical location, such as the United States. Another social network may be established to include only users having particular demographical characteristics, such as a network of users between the ages of 25 and 40, or a network of users working in a specific field. Any user demographical information, such as age, gender, ethnicity, profession, education, income, interest, marital status, etc., or any other user characteristics, such as geographical location, habits, family connections, etc., may be used as criteria when constructing a social network of users. And information relating to user characteristics may be obtained from various sources, such as from the information provided by the users to their registered accounts or from events collected while the users conduct various activities. The disclosed method for App adoption utilizes the interconnectivity of social networks to spur word-of-mouth advertising through actual app usage—integrating user action with word-of-mouth app adoption.

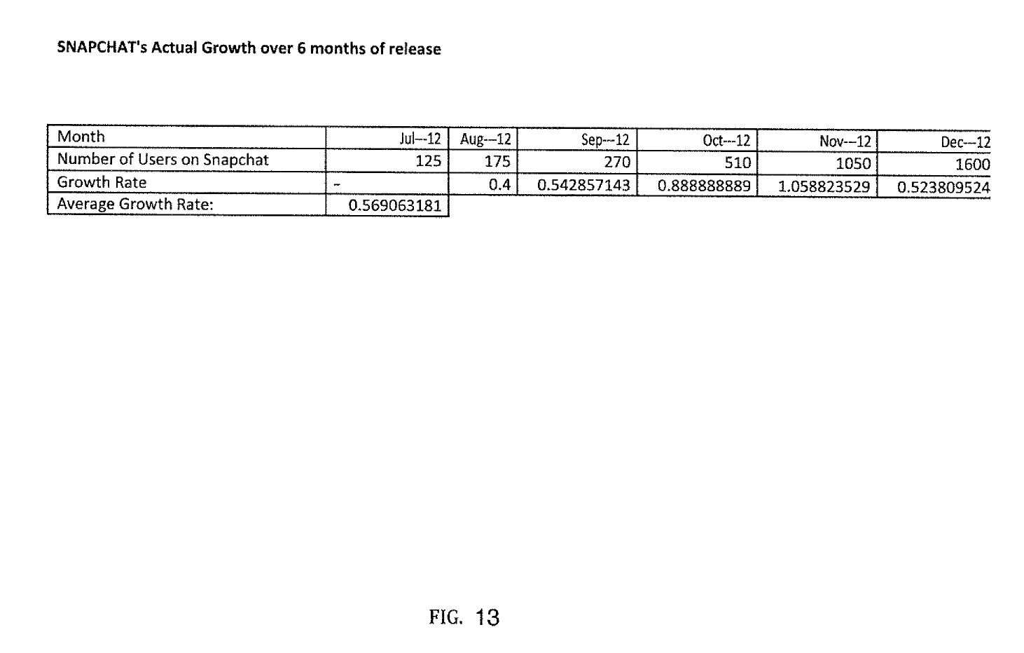

Snapchat utilizes this process of integrating user action with word-of-mouth app adoption in the user action of sending digital content to friends and receiving digital content from friends. FIG. 13 shows a table of Snapchat's actual growth over its initial 6 months of release (http://www.business2community.com/marketing/the-only-way-to-market-with-snapchat-0425212). It shows the month and number of users on its platform in thousands. The growth rate is then calculated using the formula of N2−N1/N1 where N is the number of users on its platform. Average growth rate is calculated through averaging the growth rate of the first 6 months resulting in an average growth rate of 0.569 or the proportion of second degree contacts that do download the application in order to receive the referred digital content.

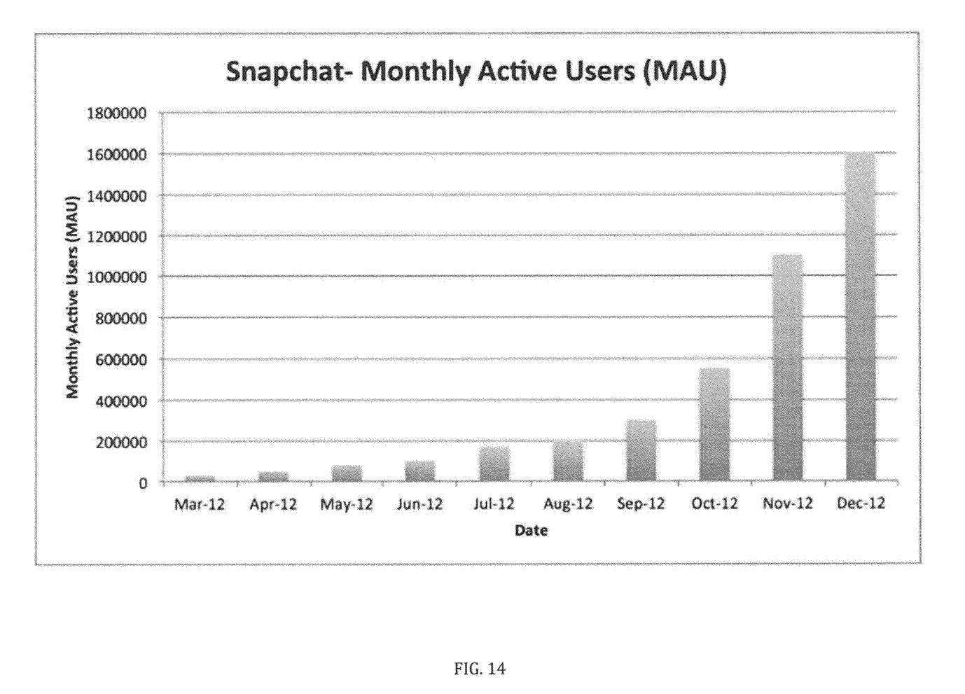

FIG. 14 shows a graph of Snapchat user growth over its initial 6 months of release (http://www.business2community.com/marketing/the-only-way-to-market-with-snapchat-0425212).

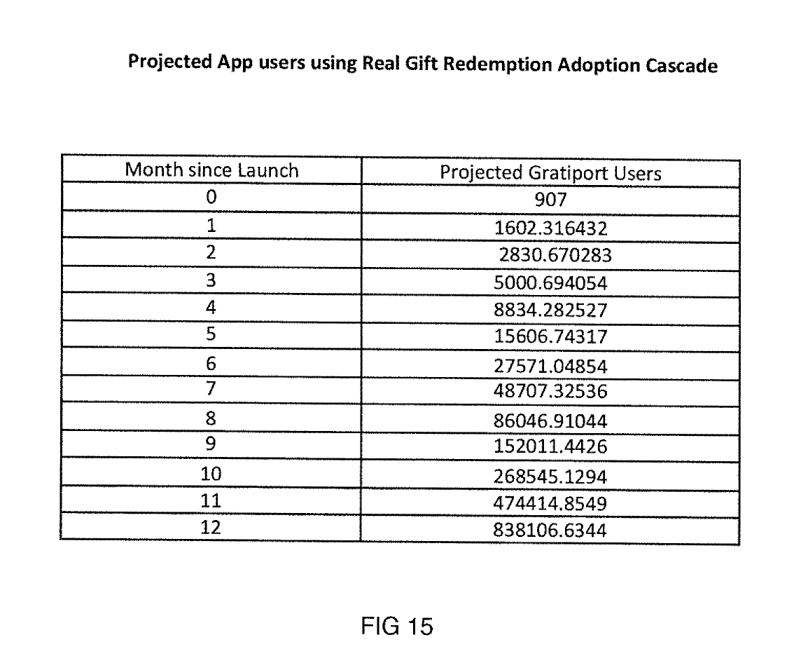

FIG. 15 shows a table of projected App users with the real gift redemption model for the first 12 months of release using the growth rate of 0.569. At initial launch, month 0, the projected number of App users is based off of the number of contacts in the initial gift giver's phone who has an initial number of 907 contacts. Using the exponential Malthusian model, the number of users projected to adopt the App through intrinsic gift redemption is 838,000 after 12 months.

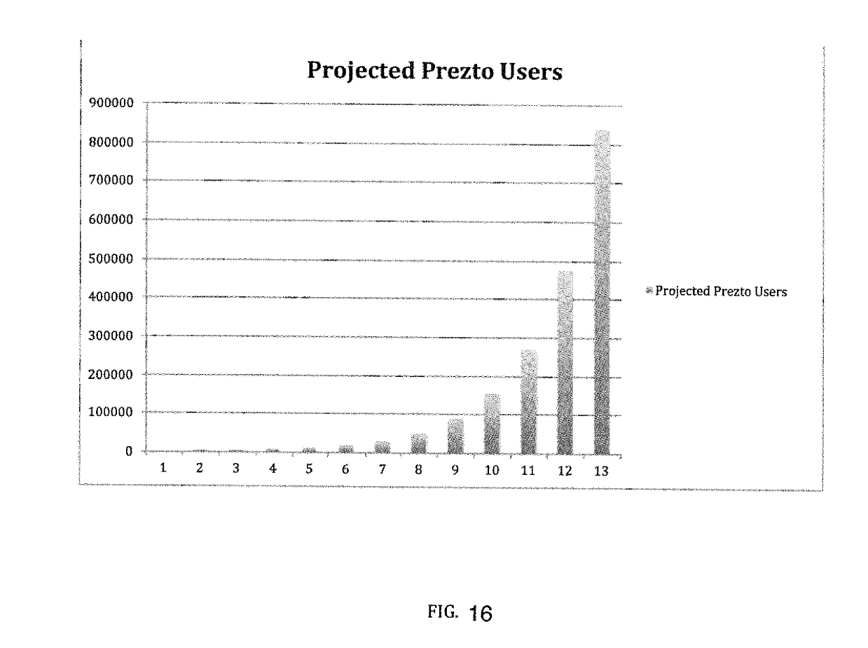

FIG. 16 shows a graph of projected App users in the first 12 months of release that use the gift redemption model consistent with the table in FIG. 13.

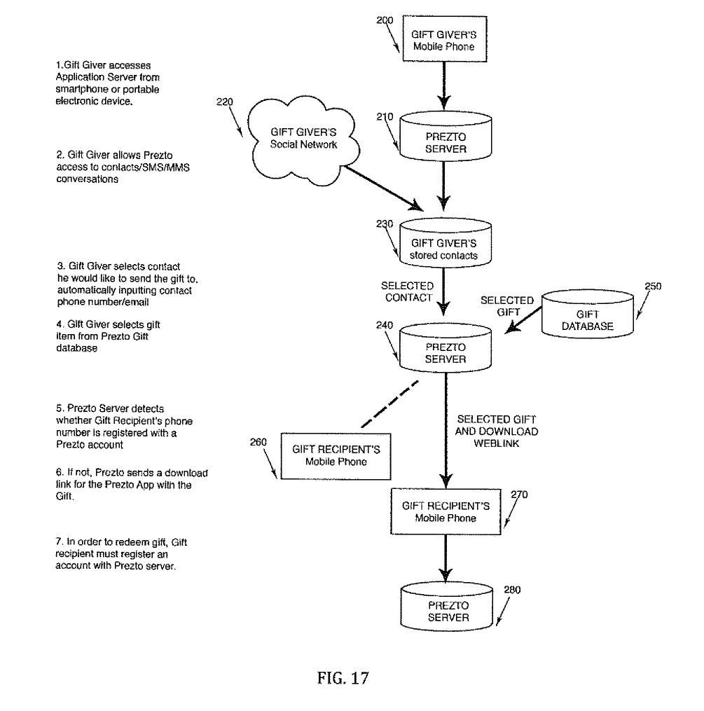

FIG. 17 shows a technology block diagram of the adoption cascade process from one gift giver to the gift recipient. The gift giver 200 accesses the Prezto server 210 by opening up the Prezto Application on the gift giver's smartphone or portable electronic device. The Prezto server 210 accesses the gift giver's social network cloud 220 through access into gift giver's stored contacts 230. The gift giver's social network cloud refers back to FIG. 10 illustrating a sample social network of an online user. The gift giver selects a contact from his stored contacts on his smart phone or portable electronic device to send the gift to—intrinsically motivating him to allow Gratiport access to his social network through the actual deed of giving. The gift giver chooses the gift recipient and inputs that selected contact's mobile number into the Prezto server 240. The gift giver then chooses the image of the selected gift that has specific intrinsic or symbolic meaning to the gift recipient. The gift giver inputs the selected gift from the Prezto gift database 250. The Prezto server 240, detects whether the Gift recipient's phone is registered with a Prezto account. If the gift recipient already has downloaded the Prezto app and is linked to the Prezto servers, Prezto will send the gift image as well as the QR code for the gift to the gift recipient. If the gift recipient has not downloaded the Prezto app and the gifting keyboard, the Prezto server will send the gift image as well as the download link for the Prezto App to the Gift recipient's mobile phone 270. The gift recipient will download the App—motivated through material redemption, as well as the social aspect that links them to their trusted contact or friend. The gift recipient will download the App through the Prezto web link, linking them with the Prezto Server 280 and giving them access to immediately send a gift to their own social network.

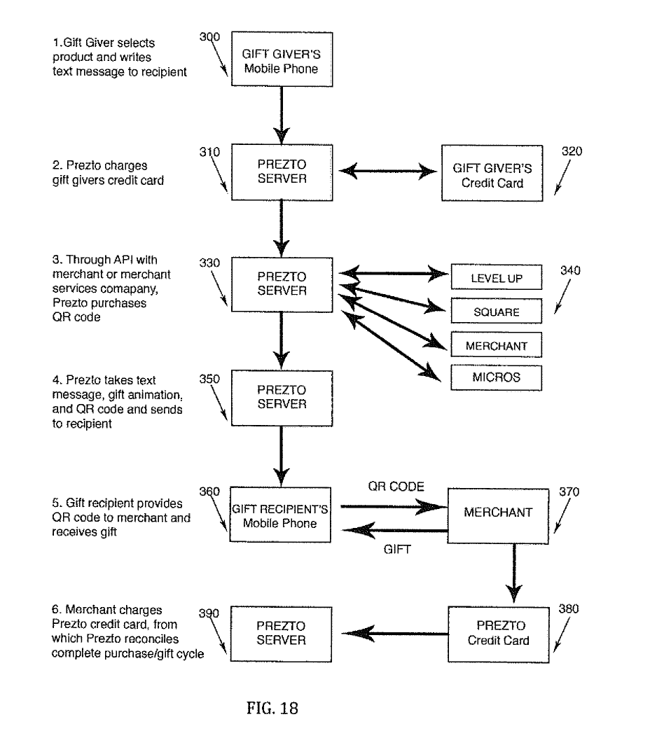

In an alternate embodiment, the invention will integrate with a Merchant Point of Sale (POS) system for simpler processing and inventory keeping. The invention in this embodiment is described as follows: FIG. 18 shows a block diagram of the present invention. Gift Purchaser 300 access his contact stored on his contacts menu stored in his portable electronic device in order to send an electronic message to appropriate recipient. Gift giver activates the Gift keyboard, chooses the gift he would like to send by selecting the Gift Character as previously detailed. The gift giver's credit card 320 is linked to the Prezto servers 310 and that credit card is charged for the exact gift amount as well as the Prezto fee of 99 cents when the gift giver sends a Gift Character to their friend. The Prezto server 330 purchases the QR code for the specific amount for the gift from payment POS system such as Level Up, Square, Micros, or individual merchant chain and Prezto server 350 attaches that QR code to the specific Gift Character and delivers that graphic as well as QR code or encrypted payment to the gift recipient's mobile phone, 360. The gift recipient takes the Gift Character and scans the attached QR code at the merchant POS system reader, 370. When the code is scanned at the Merchant POS, 370, the Prezto credit card or baby credit card, 380 is charged for the amount that the gift recipient spends from which Prezto reconciles the complete purchase/gift cycle on the Prezto server, 390.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected. Additional features of the invention will become apparent to those skilled in the art upon consideration of the description, Modifications may be made without departing from the spirit and scope of the invention.

Having described our invention, we claim:

1. A computer-implemented system comprising:
a processor, an interface and memory storing instructions to display content and accept user input to implement via a computing device, an executable application to provide a gift selected from a set of pre-determined gifts to a known person by executing the application via a computing device;
a group of virtual images of gifts associated with the executable application to provide via a display of the computing device, a graphical representation of the gifts including an indication of a purchase price of each gift, the virtual images selectable by the user via the display of the computing device to trigger the executable application to select that gift for the known person;
a purchase module that communicates with a merchant to receive and process a request to purchase and pay for the gift via the interface, the gift funded by a user and available at a location of the merchant;
a delivery module that communicates with a computing device of the known person, the delivery module creating a virtual image of the gift on the computing device of the known person, the virtual image comprising a code useable by the merchant to provide the gift to the known person, the virtual image of the gift not including a purchase price of the gift;
wherein, when the known person presents the code to the merchant, the merchant delivers the gift to the known person.

2. The system of claim 1 wherein the user adds other known persons to receive the gift.

3. The system of claim 1 wherein the location of the merchant and the proximity of the merchant to the known person is communicated to the known person simultaneously with the gift.

4. The system of claim 1, further comprising a message transmitted from the user to the known person with the virtual image.

5. The system of claim 1, wherein the graphical representation comprises an image of an item available at the merchant's location.

6. The system of claim 1, wherein the computing device is a mobile device.

7. A tangible computer readable storage medium including program code for execution by a processor; the program code, when implemented, is to provide: an executable application to provide a gift selected from a set of pre-determined gifts to a known person by executing the application via a computing device; a group of virtual images of gifts associated with the executable application to provide, via a display of the computing device, a graphical representation including indication of a purchase price of the gifts, the virtual image selectable by the user to trigger the executable application via the display of the computing device, the application i) communicating with a computing device of a merchant to receive and process a request to purchase and pay for the gift, the gift funded by a user and available at a location of the merchant, and ii) communicate with a computing device of the known person to provide a virtual image of the gift to a computing device of the known person, the virtual image comprising a code useable by the merchant to provide the gift to the known person, the virtual image of the gift not including a purchase price of the gift, and wherein, when the known person presents the code to the merchant, the merchant delivers the gift to the known person, the processor accepting a push of information from x) the merchant regarding available gifts, y) payment processing means, and acknowledgement to the user of delivery of the gift to the known person.

8. A computer-implemented method, comprising an executable application the steps of
a user accessing the application which brings up a Gift Keyboard or collection of Gift Characters which are defined as a) an image or moving image which attaches monetary value corresponding to a real redeemable gift, b) an image or moving image which communicate visually the intrinsic and emotional value of a gift for electronic messages and documents;
the user selecting, via a computer graphics display screen, a Gift Character using an exemplary user interface of Gift Character categories that narrow down Gift Character choice in a faster, more organized manner,
the user inserting, via a computer graphics display screen, the Gift Character into a delivery module that communicates with a computing device of a known person using electronic messages or posting on a social media website for redemption;
the user confirming, via a computer graphics display screen, the intent of purchasing the Gift Character by pressing a delivery mechanism;
the user confirming, via a computer graphics display screen, the total purchase of the Gift Character through agreement with a purchase module of total price and total recipients of the Gift Character through a pop up banner or push notification and confirming;
the application charging the user for the total purchase of the Gift Character or Characters including a delivery fee;
the application delivering an electronic message containing a virtual image of the Gift Character to the known person;
the known person receiving the virtual image of the Gift Character via a computing device, portable or fixed electronic device associated with the known person;
the known person initiating redemption of the real gift using the Gift Character by presenting the virtual image, the virtual image comprising a code useable by the merchant, the merchant delivering the real gift to the known person;
the merchant charging or billing the electronic Gift Character deliverer for redeemed gift; and
the application reconciling the bill through manual or automatic payout.

9. The method of claim 8 wherein the image of the Gift Character is copied and pasted from the Gift Keyboard or collection of gift images into an electronic document format outside of the executable application for redemption, the electronic document one of an email, SMS/MMS and posting on a social media website.

10. The method of claim 8 wherein the executable application organizing Gift Characters into variable Gift Character categories selected from a) price of gift, b) store location, c) geographic location, d) rarity, e) merchant preference, f) customer popularity and g) by various methods of separating and picking an item.

11. The method of claim 10 wherein the Gift Character categories are separated into one or more subsets of Gift Character categories.

12. The method of claim 8 wherein selection of Gift Character is indicated by visual or audio modification of the Gift Character selected from the group a) color and shape of Gift Character background, b) sound or music to indicate selection, and c) movement or animation of Gift Character.

13. The method of claim 8 wherein the user selects a given Gift Character and add additional known persons to receive the gift in one message within the executable application.

14. The method of claim 8 wherein pressing a confirmation key on the Gift Keyboard activates the executable application to display a confirm purchase message selected from the group a) a text bubble, and b) a text banner which confirms the exact price of total purchase, including the calculation of multiple gift recipients and multiple Gift Characters in a message.

15. The method of claim 8 wherein the known person clicks on the Gift Character which activates a list or map of merchant locations listed in the executable application

16. The method of claim 15 wherein the list or map includes information selected from the group a) distance, b) customer preference of location from gathered historical data, or c) merchant advertising giving the known person the choice of where and when and details of gift redemption based on product information provided to the known person of the gift, c) phone number, d) website, and e) address.

17. The method of claim 8 wherein user growth occurs through inherent incentives for downloading the application further comprising the steps of
the user importing known persons from contacts existing in the user's computing device;
the application detecting whether the known person whom the user is sending the Gift Character has an account registered with the application
if the known person is not registered, the application sending a downloadable link to the known person;
the known person downloading a copy of the executable application motivated by an intrinsic reward of not letting the gift going to waste; and
the known person becoming a new user through download of the application.

18. The method of claim 17 wherein the executable application tracks user actions on giving and receiving gifts on a computing device associated with the application, the actions selected from the group consisting of: a) time, b) amount, c) occasion, d) gift item, e)whether the Gift Character was redeemed for the gift that was intended by the gift giver, f) times a particular gift has been given, and g)frequency of giving a different gift.

19. The method of claim 8 wherein the executable application utilizes already existing knowledge and relationships that the user has with the known person to send additional gifts that the known person is more likely to redeem because of intangible and intrinsic qualities that may be expressed through the gift.

20. The method of claim 8 wherein the executable application manages connections between a given user and a given known person using an algorithm, the algorithm analyzing a trust score between the given user and the given known person, the trust score based on a history of gifts given and redeemed, the algorithm used to provide better recommendations or more meaningful gifts in future transactions.
